(19) United States
(12) Patent Application Publication
(10) Pub. No.: US 2009/0008186 A1
(43) Pub. Date: Jan. 8, 2009

(54) Evacuation and rescue system for elevated structures

(76) Inventors: Jack Curtis Taylor, Calgary (CA); Denny Grant Frank Deren, Calgary (CA)

Correspondence Address: ELIZABETH R. HALL, 1722 MARYLAND STREET, HOUSTON, TX, 77006, US

(21) Appl. No.: 12/215,641

(22) Filed: Jun. 27, 2008

Related U.S. Application Data
(60) Provisional application No. 60/937,863, filed on Jul. 2, 2007.

(51) Int. Cl. A62B 1/20

(52) U.S. Cl. 182/48

(57) ABSTRACT

A personnel evacuation and rescue system provides a reliable, easy to operate, and easy to access evacuation system for personnel working on elevated surfaces in hazardous environments. The evacuation and rescue system includes a ground-mounted base unit, a tubular escape chute, an upper docking portal mounted on the work platform that is mounted onto the side of a drilling or well service mast work platform, and cables for support, deployment, and retrieval of the escape chute. A quick disconnect means for anchoring a fall restraint harness used by the personnel working on the mast platform is attached to the docking platform.

### CROSS-REFERENCE TO RELATED APPLICATION

The present application, pursuant to 35 U.S.C. 111(b), claims the benefit of the earlier filing date of provisional application Ser. No. 60/937,863 filed Jul. 2, 2007 and entitled “Remote Evacuation and Rescue System for Structures.”

### BACKGROUND OF THE INVENTION

1. Field of the Invention

The present invention relates to a means for the efficient evacuation of individuals from elevated structures in the event of an emergency situation. In particular, the invention provides for the employment of a flexible chute or tube based escape channel proximal an elevated structure to allow individuals to egress rapidly from the structure.

2. Description of the Related Art

Nir discloses in U.S. Pat. No. 6,910,552 and U.S. patent application Ser. Nos. 10/214,122; 10/415,990; 10/493,159; 10/503,737; and 10/516,665 multiple embodiments of effective emergency evacuation systems for buildings and similar elevated structures. These disclosed devices utilize a single layer extensible tube or chute for personnel escape.

In each embodiment of the Nir devices, a large and relatively massive framework is installed on the elevated structure that incorporates the tube or chute of the evacuation device. The Nir devices remain encapsulated in their housings above ground level at the side of the building until an emergency, whereupon they are deployed using gravity, in whole or part, for extending the chute from an upper level to a lower level.

The Nir devices are suitable for buildings and other static structures which have good lateral bracing and are not sensitive to the substantial vertical and lateral loadings which are applied by these devices. However, in the case of masts, derricks, and other elevated lightweight structures, these devices are not suitable.

The mass of the Nir evacuation system located at upper levels provides an excessive and damaging stress, or moment on the lightweight elevated structures, particularly in an event of potential enhanced instability such as high winds. Light weight masts are frequently used in the drilling and maintenance of petroleum or geothermal wells. These masts are generally provided with integral work platforms at an intermediate elevation.

Typically, these mast structures are designed to permit highway portability and are light weight and integral with their supporting vehicle. While these mast structures are designed to withstand the significant vertical loadings required for handling long strings of tubing in a well, they are not designed for high lateral winds or other major lateral loads. Accordingly, well drilling and service operations are often shut down in high wind conditions to avoid the risk of mast overstress under combined wind lateral load and vertical loads. The addition of relatively significant vertical loadings offset laterally from the mast centerline is undesirable both from the structural capacity and road transportation standpoints.

Furthermore, accidents in petroleum or geothermal drilling and well service are relatively violent and have rapid onsets compared to, for example, building fires. During blowouts, solid, liquid, and gaseous emissions are launched at high velocities. Projectile impact damage may occur. Liquids and gases may be poisonous, and can ignite with great intensity. Personnel working on the mast upper level platforms are the most exposed individuals in the event of a well blowout and even the relatively short period of time required for deployment of the Nir systems may be inadequate for allowing egress of endangered personnel. Accordingly, reliability and speed of egress are critical for those personnel. Escape by the mast ladder is often not feasible, and the elevation of the work platform rules out jumping as a practical option.

Because a well site is often congested with various items of equipment and structures, as well as having a strictly defined and relatively small footprint of surface area, there is a need for a personnel evacuation and rescue system which is not limited to a single deployment direction from its attachment on the mast work platform, but can be situated so that it does not interfere with other equipment on the location within the boundary restrictions.

A need exists for a personnel evacuation and rescue system which is compatible with the masts used for petroleum and geothermal drilling and well servicing rigs. Such a personnel evacuation and rescue system should be readily and rapidly field deployed and stowed. Additionally, there is a need for a personnel evacuation and rescue system which can provide sufficient resistance to high temperatures, flame, oilfield chemicals and well fluids, and reasonable projectile impact resistance in order to permit successful personnel egress.

### SUMMARY OF THE INVENTION

A personnel evacuation and rescue system for use with well drilling and servicing rigs is described that provides a reliable and easy to operate and access personnel evacuation system for personnel working on elevated surfaces in hazardous environments.

The evacuation and rescue system includes a ground-mounted base unit, a tubular escape chute, an upper docking platform mounted onto the side of a drilling or well service mast work platform, and cables for support, deployment, and retrieval of the escape chute. In addition, a quick disconnect means for anchoring a fall restraint harness used by the personnel working on the mast platform is typically attached to the docking platform.

One embodiment of the invention is a portable personnel evacuation system comprising: (a) a escape chute, including multiple coaxial fabric layers and a helical extension spring; and (b) deployment means for reciprocably moving the escape chute between a first position and a second position, wherein the first position is expanded between a ground base unit and an elevated work platform and the second position is compressed and stored on the ground mounted base unit.

An embodiment of the portable personnel evacuation system includes a deployment means having a sheave mounted on the elevated work platform; an extension winch mounted on the grounded base unit; an extension cable, wherein one end of the extension cable is connected to the extension winch, a segment of the extension cable is located between the inner layer of the chute and the helical extension spring along the length of the escape chute, a portion of the extension cable is in communication with the sheave mounted on the work platform, and a second end of the extension cable is attached to a distal end of the escape chute; a retrieval winch mounted on the grounded base unit; and a retrieval cable, wherein one end of the retrieval cable is connected to the retrieval winch, a segment of the retrieval cable is located between the inner layer of the escape chute and the helical extension spring along the length of the escape chute, and a second end of the retrieval cable is attached to a distal end of the escape chute.

Another embodiment of a portable personnel evacuation system for evacuating personnel from elevated structures comprises: (a) a ground mounted base unit, wherein the base unit includes an extension winch connected to a first end of an extension cable and a retrieval winch connected to a first end of a retrieval cable; (b) a multi-layered escape chute, wherein a portion of the extension cable and the retrieval cable located between the inner layer of the chute and the helical extension spring traverse a length of the escape chute and wherein a second end of the extension cable and the retrieval cables are connected to a platform end of the escape chute; and (c) a sheave mounted on a docking portal of an elevated work platform, wherein a length of the extension cable communicates with the sheave.

Yet another embodiment of a portable personnel evacuation system for evacuating personnel from elevated structures comprises: (a) a ground mounted base unit positioned at a predetermined distance from a well, wherein the base unit includes a power unit, an extension winch connected to a first end of an extension cable, and a retrieval winch connected to a first end of a retrieval cable; (b) a tubular escape chute that is selectably extendable, the escape chute having multiple flexible coaxial fabric layers and a helical extension spring, wherein a portion of the extension cable and the retrieval cable traverse a length of the escape chute between two layers of the chute and wherein a second end of the extension cable and the retrieval cables are connected to a launch frame mounted on a distal end of the escape chute; (c) a docking portal mounted on an elevated work platform; (c) a sheave mounted on the docking portal, wherein a length of the extension cable communicates with the sheave when the escape chute is being extended between the ground mounted base unit and the docking portal; and (d) a fall restraint anchor hook mounted on the docking portal of the work platform.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a side profile view of the deployed personnel evacuation and rescue system installed at a well location.

FIG. 2 is a side profile view of the personnel evacuation and rescue system with the escape chute retracted in its stowed position.

FIG. 3 is a plan view of the well location of FIG. 1, showing the personnel evacuation and rescue system in its stowed position normal to the outer side of the work platform of the rig.

FIG. 4 corresponds to FIG. 3, but illustrates the flexibility of placement for the personnel evacuation where the rescue system can be deployed at a range of angles to the outer side of the work platform of the rig.

FIG. 5 is a plan view of the base unit.

FIG. 6 is a plan view of the work platform.

FIG. 7 is an oblique view of the work platform of FIG. 6.

FIG. 8 is a side view of a worker on the work platform with the extended escape chute attached to the platform.

FIG. 9 is a side view of a segment of the extended escape chute.

FIG. 10 is a transverse cross-sectional view of the escape taken along line 10-10 of FIG. 9.

FIG. 11 is a partial longitudinal cross-sectional view of one side of the extended escape chute taken along line 11-11 of FIG. 9.

FIG. 12 corresponds to FIG. 11, but shows the chute cross-section with the tube in its partially extended or retracted condition.

FIG. 13 is an exterior plan view of the innermost layer of the chute with the helical spring disposed and the cables disposed on the inner side of the innermost layer.

FIG. 14 is a side profile view of a straight shank U-shaped fall restraint anchor hook that is mounted on the work platform.

FIG. 15 is a side profile view of a bent shank fall restraint anchor hook that is mounted on the docking portal of the work platform.

FIG. 16 is a side profile view of a straight shank U-shaped anchor hook having a retainer toggle to prevent inadvertent release of a retained fall restraint line.

FIG. 17 is an oblique view of the hammock connected on one end to the proximal end of the escape chute and on a second end to the base unit.

### DESCRIPTION OF THE PREFERRED EMBODIMENTS

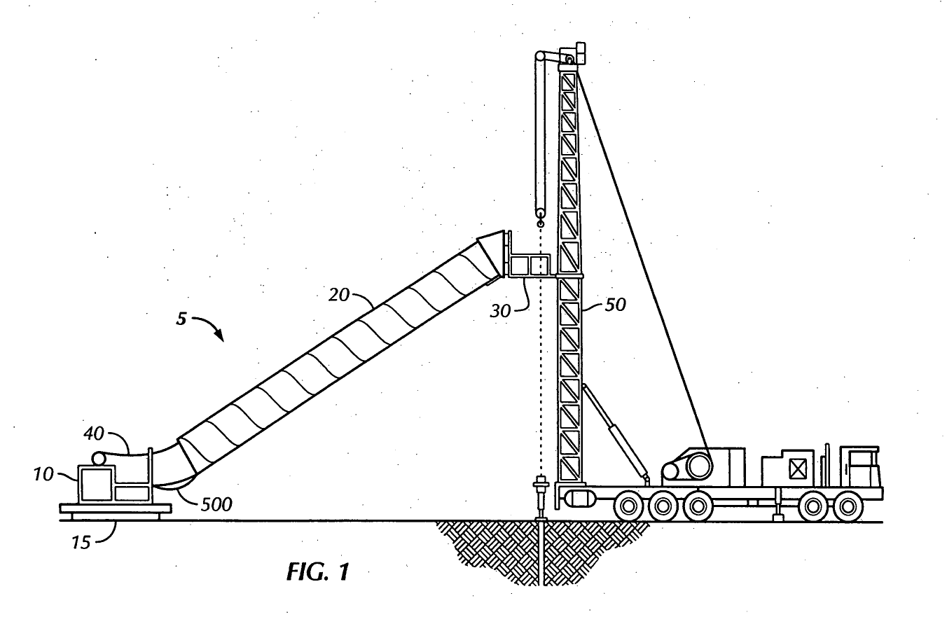

The personnel evacuation and rescue system 5, shown in FIG. 1, is a reliable and easy to operate and access evacuation system for personnel working on elevated surfaces in hazardous environments. Specifically, the present invention is intended to provide a practical escape means for personnel working on elevated platforms on petroleum and geothermal drilling and well servicing rigs.

The personnel evacuation and rescue system 5 includes a ground-mounted base unit 10, a tubular escape chute 20, an upper docking platform 305 mounted onto the side of a drilling or well service mast work platform 30, and cables 40 for support, deployment, and retrieval of the escape chute. Also included as part of the docking platform is a quick disconnect means for anchoring fall restraint harnesses used by personnel on the mast work platform.

Referring to FIG. 1, one embodiment of the personnel evacuation and rescue system is shown in side profile view as deployed ready for use on an active well location. On the right side of the figure is a vehicular mounted rig having a field erected unitized mast 50. The mast 50 is shown in its erect position, with its hoisting gear axially centered over the wellhead of the well. The vehicular mounted rig is shown in a simplified arrangement for purposes of clarity, with equipment like mud tanks, mud pumps, flow lines, choke and kill manifolds, and the like omitted for clarity. The rig is shown with its mast 50, drawworks (winch system), crown block, and traveling block and the winch lines. The crown block is the set of sheaves at the top of the mast, while the traveling block is a set of sheaves with a hook on its lower side. The lines supporting the traveling block are multi-parted.

The mast 50 of the rig is an elongated vertical rectangular cross-section truss having coaxial trunnion pins on its forward lower corner, a top mounted crown block, and a work platform 30 mounted on its rear side at an intermediate height. The mast 50 is selectably erectable by means of a pair of identical hydraulic cylinders anchored with transverse horizontal axis pin connections to the trailer bed at their first ends and connected by transverse horizontal trunnion pins to the forward side of the mast 50 at a height intermediate to the mast 50. When the cylinders are retracted, the mast 50 is rotated forward to rest against stops (not shown) at the forward end of the trailer. When the cylinders are extended, the mast 50 is moved to its erect vertical position.

Although the mast 50 is designed to have minimal weight in order to comply with mandated vehicle load limits for highway travel, the mast 50 is designed to handle the relatively large axial loads required in drilling and production. However, the light weight elevated mast 50 is not designed to handle major wind or seismically induced lateral loads and has very little reserve strength for parasitic loads on its work platform 30. The weight component of such parasitic loads applied to the work platform is necessarily eccentric from the mast vertical axis; so that the axial load capacity of the vertical mast chords on the rear side of the truss is reduced by the additional bending moments in the truss. Additionally, if any side loads are applied to the work platform due to wind or cable tension forces related to support of a parasitic structure attached to the work platform, the additional bending moments further reduce the mast axial load capacity. Accordingly, a practical design requirement for a personnel evacuation and escape system attaching to the work platform is that it be light weight and exert minimal side loads on the mast.

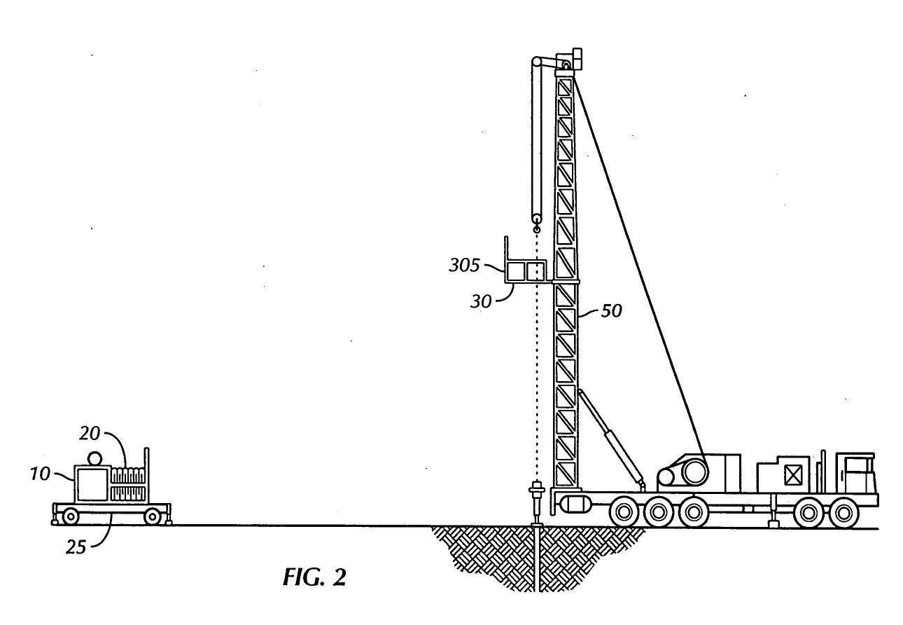

The personnel evacuation and rescue system 5 is a self-contained mobile system that provides a quick and safe exit from an elevated structure to the ground. The system is portable and typically contained on a sled, such as shown in FIG. 1, or on a trailer, such as shown in FIG. 2. The system includes a ground-mounted base unit 10, a tubular escape chute 20, an upper docking portal 305 mounted onto the side of a drilling or well service mast work platform 30, and cables 40 for support, deployment, and retrieval of the escape chute. Also included as part of the docking platform is a quick disconnect means for anchoring fall restraint harnesses used by personnel on the mast work platform.

The personnel evacuation system 5 has a selectably deployable escape chute 20 that is reversibly attached to the docking portal 305. When the chute 20 is deployed it provides a protected descent for personnel from the docking portal 305 to the ground. Generally, a hammock 500 is attached to the proximal end of the chute which is connected to the base unit 10, and a solid launch frame 220 is mounted on the distal end, or platform end, of the chute 20 which is reversibly attached to the docking portal 305.

The Work Platform and Docking Portal

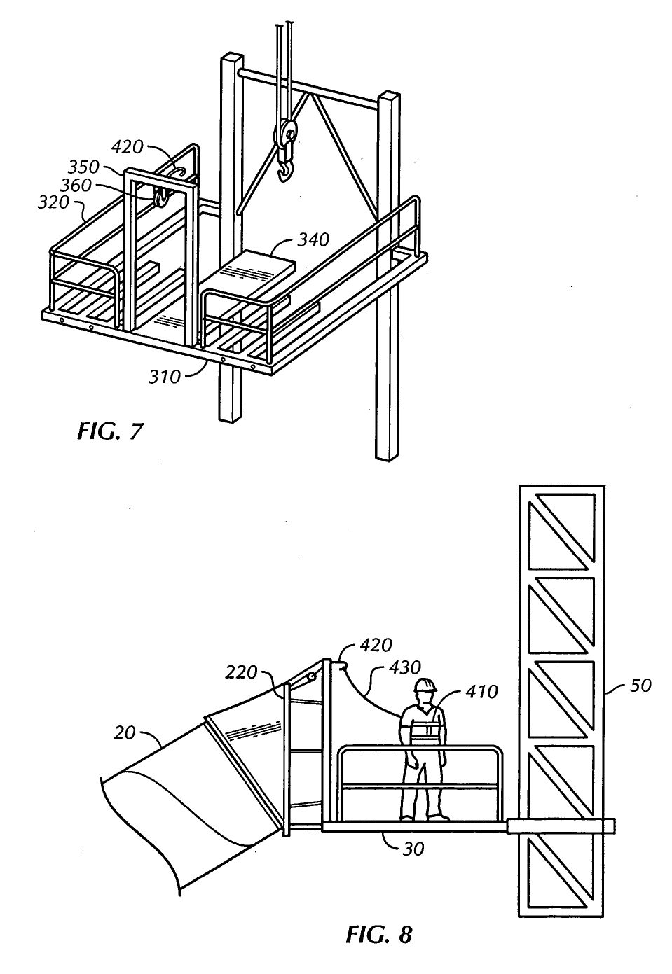

The work platform 30 of the rig is shown in a plan view in FIG. 6 and an oblique view in FIG. 7. The work platform 30 is accessible from below by means of a ladder (not shown) affixed to the exterior side of the mast of the rig. The work platform 30 provides a working surface for personnel involved in adding or removing tubing or pipe segments from the drill string.

Although not shown in the Figures, the work platform 30 is typically hingedly mounted on the rear side of the mast 50 of the rig. The hinged mounting allows the platform 30 to be stowed during transport. The work platform 30 has a horizontal frame 310. As seen in FIG. 7, the work platform 30 has a central plank 340 extending from the center rear of the frame 310 towards the mast 50. Handrails 320 are placed around most of the periphery of the work platform 30, but are not used around the mast side of the platform 30 because of the need for personnel to access the pipe and pipe handling mechanisms attached to the traveling block.

Because of the danger of falling from the platform 30, personnel working on the platform 30 will usually wear a fall restraint harness 410 as shown in FIG. 8. The fall restraint harness 410 is provided with an anchored tether line 430 having inertial reels for permitting normal movement but capable of arresting rapid motion, such as falling.

An escape opening, or docking portal 350, is provided on the rear side of the platform 30 to permit entry of personnel from the platform to the interior of the escape chute 20 and to provide a secure site for attaching the distal end, or platform end, of the escape chute 20.

The docking portal 350 can be a variety of shapes and sizes. One embodiment of the docking portal 350 is a separate structure welded onto the platform 30. The docking portal 350 seen in FIG. 7 is illustrated as typical to the industry. Often the docking portal is welded to the center of the rear horizontal beam of the platform frame 310. The sides of the docking portal 350 are usually attached to the handrails 320. Hand rails 320 are cut or reconfigured to provide clearance for the mounting of the docking portal 350, while still providing protection against a fall from the platform.

Alternatively, the docking portal may not be a separate structure but may result from a reconfiguration of the handrails 320. For example, the handrails 320 may provide the frame of the docking portal. In this case the escape chute 20 attaches to the sides of the handrails 320 that have been strengthened for that purpose.

In order to stabilize the docking portal 350 for loads imposed by the escape chute 20 and its supporting cables, a wire cable may be secured to an anchor point at the crown of the rig and travel down to the top of the docking portal 350. This wire cable translates the majority of the vertical loads into the crown of the mast 50. Alternatively, the docking portal 350 may be braced by additional vertical structural members, knees, and/or gussets connected to the platform 30 and braced against the mast 50 and/or platform frame 310.

A sheave 360 for engagement with the extension cable 40a of the escape chute 20 is mounted on the top bar of the docking portal 350 with its axis of rotation parallel with the plane of the docking portal 350 and either lying in the plane of the docking portal or positioned slightly forward of the docking portal 350. The sheave 360 and its shaft are illustrated as typically mounted. However, alternate designs of sheaves are commercially available, and the sheave 360 is not necessarily mounted symmetrically.

Typically the escape chute 20 has a rigid steel launch frame 220 attached to the distal end of the chute 20. The launch frame 220 provides support for the escape chute 20 where the chute 20 attaches to the docking portal 350. The launch frame 220 and thus the escape chute 20 are secured at multiple sites to the docking portal 350. The launch frame 220 ay alternatively, and/or additionally, be secured to the platform frame 310 or the handrails 320

A fall restraint anchor hook 420 is welded onto the top of the back side of the docking portal 150 as seen in FIG. 8. The quick release anchor hooks 420 are beneficial should a well blowout or other well emergency occur. Because well emergencies can arise very suddenly, unfastening a conventional fall safety harness 410 in order to permit personnel egress from the work platform 30 can require considerably more time than the minimum safety period.

FIGS. 14, 15, and 16 illustrate three embodiments of quick release anchor hooks that may be used to hold the fall arrest harness tethers 430. Anchor hooks 420 and 422 permit the automatic disengagement of the fall restraint system when the person enters the escape chute 20; whereas the anchor hook 424 may be suitable for either automatic disengagement or minimal intervention, according to the preferences of the operator.

Each of the anchor hook embodiments is oriented and mounted similarly on the docking portal 350. Normally the force applied to the anchor hook by the fall restraint system while the personnel are working on the platform 30 will be directed to some degree both towards the mast and downwardly. Accordingly, the anchor ring of the fall restraint tether line 430 will tend to be pulled into the curved portion of the anchor hook, rather than away toward where the ring would release from the hook.

The first anchor hook 420 shown in FIG. 14 is fabricated in a simple U shape, with the U lying in a vertical plane with its legs horizontal. Typically, the bend of the U will be an approximately circular 180° arc, although this is not a requirement. The opening of the anchor hook 420 is oriented away from the mast of the rig. The size of the anchor hook is such that it easily accommodates a ring attached to the end of a fall restraint tether line 430 or a similar ring mounted on the inertial reel of the fall restraint system.

FIG. 15 discloses a second embodiment of the anchor hook 422. The form of the second anchor hook is that of a distorted U with both legs horizontal, but with the diameter of the bent portion larger than the spacing between the horizontal legs. The primary bend of the U is more than 180°, but the bar is counterbent by an amount equal to the excess of the primary bend over 180°, so that the lower straight portion of the U is horizontal. The anchor hook 422 provides a position for the end ring of the tether line 430 that is lower than the release position, thereby helping to prevent accidental disconnections.

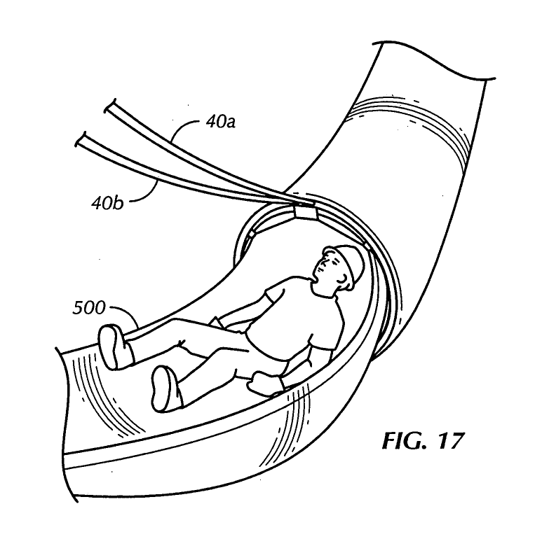

FIG. 16 shows a third embodiment of the anchor hook 424. The anchor hook 424 is provided with a spring loaded toggle retainer mounted on the upper leg of the hook 424 and biased to abut the lower side of the hook. The fall restraint ring on the end of the tether line 430 is readily slipped onto the hook 424.

A slack fall restraint tether line 430 can more easily disconnect inadvertently from the anchor hooks 420 and 422 than from the anchor hook 424. The use of anchor hook 424 requires the displacement of the toggle 426 to mitigate the potential for accidental disconnection. If, according to operator preference, manual displacement of the toggle 426 is required to release the anchor 424, this assembly has the drawback of slowing operator egress.

The Base Unit

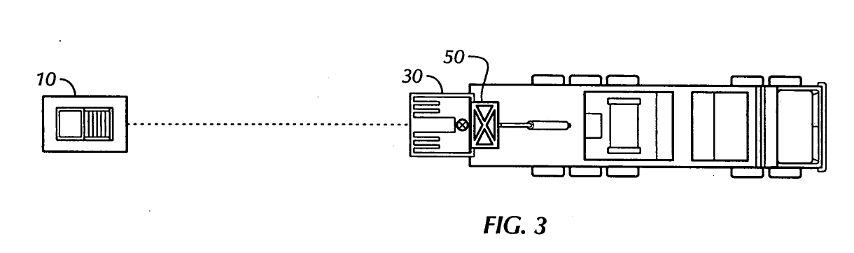

In FIGS. 1, 2 and 3, the ground mounted base unit 10 is positioned to the rear of the trailer mounted rig and on the longitudinal axis of the trailer, and the escape chute 20 is suspended by internal cables 40 extending between the base unit 10 and the docking portal 350 mounted integrally with the work platform 30 of the rig.

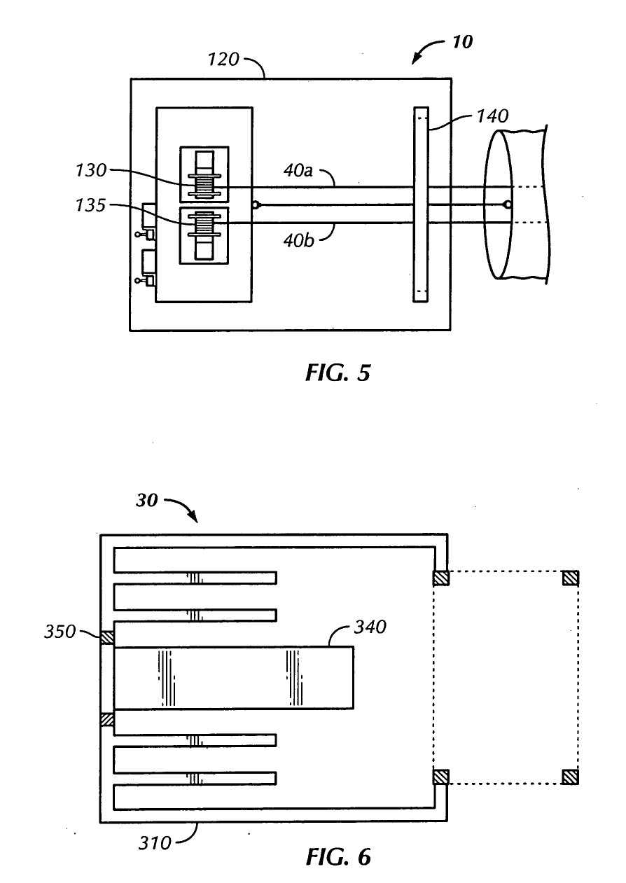

The base unit 10 must be portable and is typically mounted on a skid 15 or a wheeled trailer 25. The base unit 10, shown in FIGS. 1 and 5, often has a deck plate which serves as a mounting surface for the other components of the base unit 10. However, the other components may be directly mounted to the skid 15 or the wheeled trailer 25.

At the rear side of the base unit 10 is a power unit housing typically containing a diesel engine, a radiator, a fuel supply, a battery for electrically starting the engine, and a means for rotating the pair of winches 130 and 135 which are used to deploy and retrieve the escape chute 20. At the forward side of the base unit 10, a vertical portal frame 140 parallel to the forward side of the base unit 10 is generally mounted.

The Cables

There are two winch cables 40a and 40b that are releasably attached to the two winches. The extension cable 40a is connected to the extension winch 130 and the retrieval cable 40b is connected to the retrieval cable 40b. When the escape chute is being deployed the cables 40a and 40b are attached to the proximal end of the chute 20.

The extension cable 40a extends from the extension winch 130 and runs through the length of the chute 20 positioned between two layers of the chute. The extension cable 40a exits the distal end of the chute 20 close to the docking portal 350 and extends to the upper side of the sheave 360 and back over the sheave 360 in the direction of the base unit 10 to attach to the upper edge of the distal end of the escape chute 20 or to the launch frame 220 facing the mast 50. The connection of the extension cable 40a to the mast side of the escape chute 20 is selectably releasable. The extension cable 40a may either be released, or left in place for additional chute support after deployment of the chute 20, according to operator preference.

Similarly, the retrieval cable 40b extends from the retrieval winch 135 and passes through the length of the chute 20 between two chute layers and is attached to the upper edge of the escape chute 20 or the launch frame 220 facing away from the mast 50.

The extension cable 40a and the retrieval cable 40b are run through separate parallel constrained paths between the inner and outer layers of the multilayered escape chute structure. By independently controlling lengths of extension cable 40a and retrieval cable 40b, in conjunction with differing frictional resistance as the cables run through their separate paths, the chute 20 and the launch frame 220 may be substantially manipulated during deployment and retraction. For example, the chute may be maintained at a height sufficient to prevent ground contact during deployment. As another beneficial example, such manipulation greatly facilitates docking the launch frame 220 to the platform 30, the platform frame 310, or the docking portal 350.

In order to minimize both cable stiffness and weight, preferred embodiments of the cables are constructed of a high strength synthetic material such as AmSteel-Blue™ (produced by Samson, Ferndale, Wash.).

The Chute

In contrast to the prior art, the construction of the escape chute 20 involves multiple layers and means for holding the chute 20 open in a more or less circular shape, and means for attaching to the docking portal. The construction of the chute 20 is predicated upon maintaining sufficient strength and heat/flame resistance without excessive weight. The inner diameter of the chute 20 is typically approximately 3 to 4 feet (1 m).

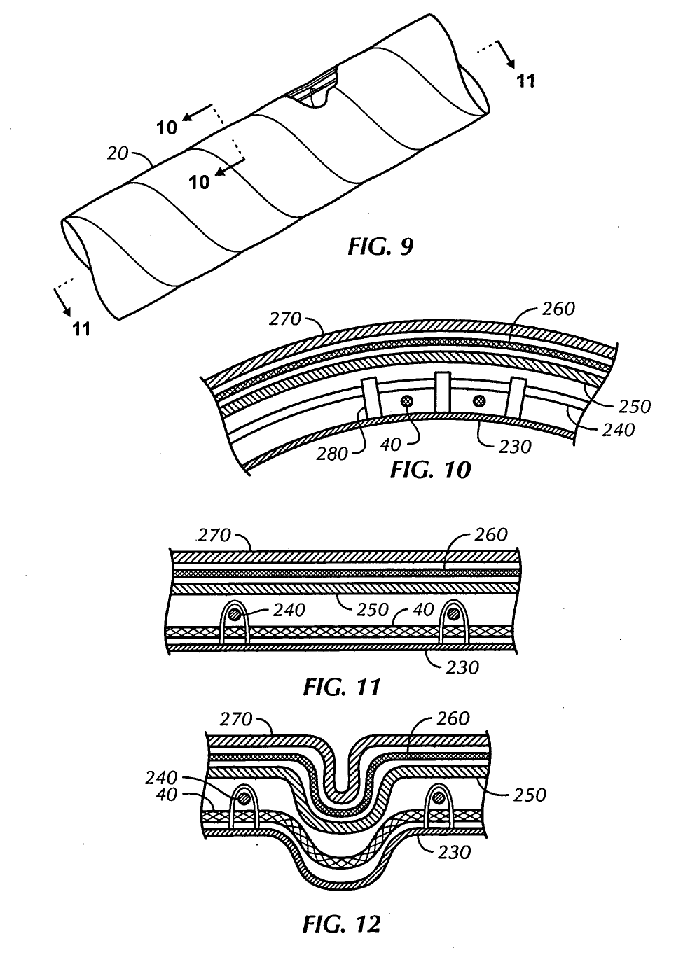

The escape chute 20 is multi-layered as illustrated in FIGS. 9 through 13. A preferred embodiment of the escape chute 20 has four coaxial fabric layers and a coil spring that provides for a structural exoskeleton.

The innermost layer 230 of the escape chute 20 provides a strength component to the chute 20. The innermost layer 230 is a high tensile strength fabric that combines the necessary load bearing capabilities and a durable sliding surface. The inner layer is selected for high strength, tear resistance, low tendency to cause skin irritation in sliding contact, and chemical resistance. The inner layer generally is the strongest layer of the escape chute 20. Preferably, the innermost layer 230 is fire retardant with support webbings spaced around its exterior, running along its full length to provide a tensile strength of about 30,000 pounds or more.

The second layer 250 is a thermal insulation layer, such as a silica ceramic blanket material. Preferably, the second layer 250 can resist temperatures to 1300° C. In the event of a fire, this second layer 250 thermally isolates the inner workings of the chute, as well as the evacuee while the evacuee is in the “flash zone.”

The third layer 260, intermediately positioned between the thermal insulation layer 250 and the outermost layer 270, is a fire protection layer. The fire protection layer 260 is made of a fire resistant fabric and assists in protecting the overall evacuation system. A preferred embodiment of the fire protection layer 260 is a fabric woven of oxidized carbon yarn that fully encompasses the entire length of the escape chute 20 and provides a fire barrier resistant to 1200° C.

The outermost layer 270 is a generally protective layer. The outermost layer 270 is selected to exhibit the characteristics of low friction, weather and chemical resistance and tensile and puncture strength. The outermost layer 270 is typically a fabric cover that acts as a barrier to protect the inner layers of the escape chute 20 from exposure or attack from UV rays, oils, acids and chemicals, water, ice and snow. For example, spunbonded polyolefin, spun and woven polyethylene, or polypropylene fabric is suitable for the outer layer.

The diameter difference between the individual layers of the escape chute 20 is relatively small. The material of the individual layers is provided with sewn lap joints in order to construct the individual tubular layers. The tubes can be formed of individual helical spirals of linear sheet material having helical lap joints or from linear sheet material with lap joints which are parallel to the longitudinal axis of the tube. Through stitching can be used to hold the individual tube layers so that their relative axial and circumferential positions are substantially invariant.

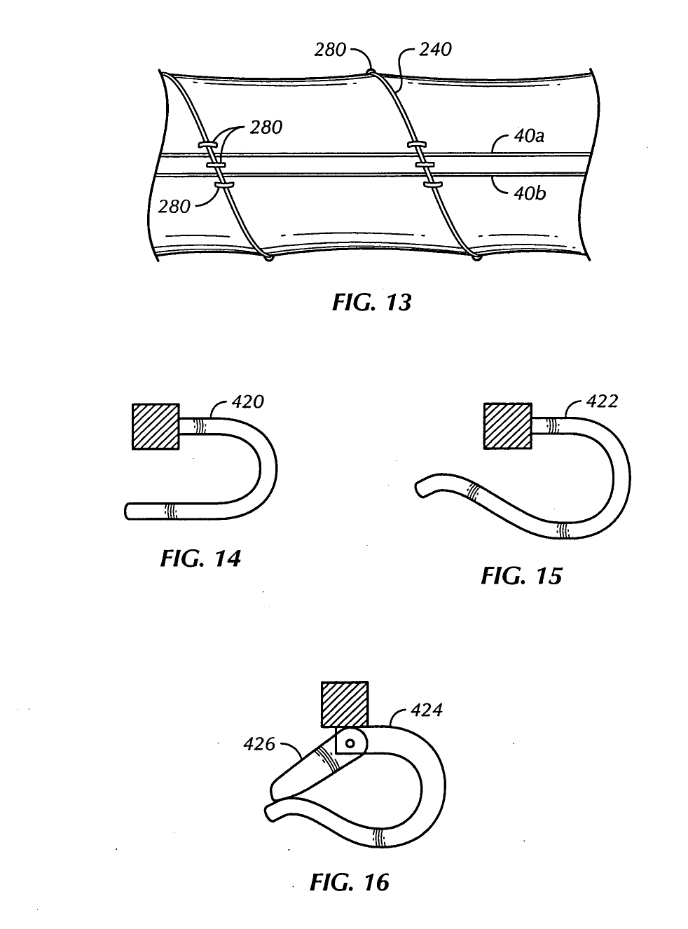

In order to maintain the chute 20 in an open, approximately circular configuration, the innermost layer is loosely attached to a steel expansion hoop 240. The steel expansion hoop 240, best seen in FIG. 13, is a large helical spring using round wire with a small cross-sectional diameter relative to the helix diameter. The at-rest helix diameter is a few percent larger than the diameter of the extended escape chute 20.

The steel expansion hoop 240 is constructed as a very weak extension spring, with relatively high strength steel wire being used and minimal coil spacing. Because the unusually large difference between the helix and the wire diameters, the steel expansion hoop spring can be greatly extended from its at-rest condition with only minimal axial force. At the same time, the strength and stiffness of the individual coils is sufficient to maintain the tube cross-section open and roughly circular, even when subject to lateral wind loads and the weight of the evacuee inside.

The steel expansion hoop 240 is closely attached to the exterior of the innermost fabric layer 230 by short flat straps sewn to the innermost layer 240 at their distal ends, as seen in FIG. 13. Three spaced-apart parallel straps are used on the top side of the tube, and other straps can be used as necessary in order to couple the escape chute walls to the expansion hoop 240. The sets of straps for individual coils of the expansion hoop 240 are axially spaced apart with regular spacings determined by the number of coils and the extended length of the escape chute 20. The free ends of the expansion hoop spring are similarly anchored by straps at the distal ends of the escape chute 20. Circular closed end coils of the spring are used to form continuous circular metallic end structures which are attached by regularly spaced straps around the circumference of each of the ends of the escape chute 20.

Referring to FIG. 13, it can be seen that the portions of the extension and retrieval cables 40a and 40b are entrapped circumferentially between the helical expansion hoop 240 and the innermost layer 230 the escape chute 20. The set of three parallel and spaced apart straps 280 engaged with each expansion hoop coil and sewn on the upper side of the inner layer of the chute 20 are used to circumferentially constrain the cables 40. These straps 280 are approximately parallel to the longitudinal axis of the escape chute 20. The cables 40a and 40b are separated by the center strap of the set of three. Additional circumferentially oriented straps which are positioned intermediately between adjacent expansion hoop coils can be used if desired to further control the cable positions between the adjacent coils of the expansion hoop.

Deployment of the Evacuation System

The personnel evacuation and rescue system 5 is transported to the well location via its own self-contained base unit 10. The base unit may be situated on a sled 15 that is transported on a trailer or other vehicle as shown in FIG. 1, or the base unit 10 may be integral to a wheeled trailer 25 as shown in FIG. 2.

When the base unit 10 arrives on location, it is positioned at a predetermined distance and angle from the work platform 30. The site of the base unit 10 governs the egress termination point. Once the base unit 10 is positioned, it is anchored or stabilized.

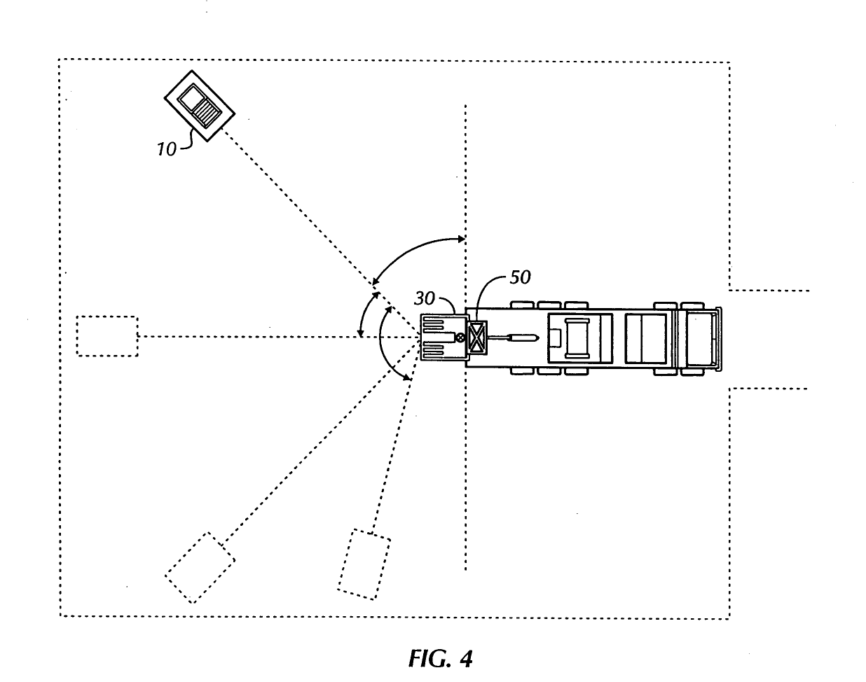

Uniquely amongst currently available advanced evacuation systems, the personnel evacuation and rescue system 5 has flexibility in its positioning. FIG. 4 illustrates the flexibility of placement for the base unit 10. For example, the base unit 10 may be positioned and the escape chute 20 deployed normal to the rear side of the work platform 30, or the base unit 10 may be positioned and the escape chute 20 deployed at a range of angles to the outer side of the work platform 30. The fact that the evacuation system 5 does not have to extend to ground level perpendicularly to its attachment on the mast work platform or some singular predetermined angle, as in other currently available advanced evacuation systems, but can be situated at a wide variety of positions relative to the well. In fact, the evacuation system can be positioned at any of a wide array of angles from the work platform as shown in FIG. 4. This versatility in placement of the evacuation system 5 allows the escape chute 20 to be deployed around obstacles such as flare pits, tanks, sumps, manifold shacks, pump jacks, production facilities, lay down equipment and the like.

The travel fastenings that anchor the chute 20 are first released. The retrieval cable 40b travels from the retrieval winch 135 through the chute 20 and terminates at the launch frame 220. The retrieval cable 40b becomes the primary catenary support line during the operation of the escape chute 20.

The extension cable 40a is the primary hoisting line for the escape chute 20. The extension cable 40a passes from the extension winch 130 through the chute 20 and then is extended over the sheave 360 mounted on the docking portal 350 and finally brought around the sheave 360 and attached to the fitting provided at the upper edge of the escape chute 20 or the launch frame 220 facing the mast 50.

As the extension winch 130 is tightened against the extension cable 40a, the extension cable 40a pulls through the sheave 360 and the escape chute 20 is pulled from its stowed position on the base unit 10 until its forward edge or launch frame 220 reaches the docking portal 350 of the work platform 30. The retrieval cable 40b is allowed to extend along with the chute 20 with just enough tautness to keep the chute 20 off the ground. As the chute 20 and launch frame 220 approach the work platform 30, tautness of both of the cables 40a and 40b are moderated to facilitate the attachment of the launch frame 220 to the docking portal 350.

Preferred embodiments of the chute 20 have a launch frame 220 attached to the platform end of the chute to provide support for the escape chute 20 where the chute 20 attaches to the docking portal 350. Once the launch frame 220 is raised to the docking portal 350, a male-female connection is latched and a safety pin installed. For example, one embodiment of the chute 20 has a pintel hitch located at the base of the launch frame 220 that attaches to the hitch receptor on the chute side of the docking portal 350 to provide attachment support for the chute 20. The launch frame 220, and thus the escape chute 20, may then be secured at multiple sites to the docking portal 350. For example, stabilizer handrails are often secured between the launch frame 220, at the user entryway, and the hand railings 320 of the platform 30. These stabilizing handrails further stabilize the attachment of the launch frame 220 and act as safety handrails between the platform 30 and the chute 20.

Once the launch frame 220 and the chute 20 are attached to the docking portal 350, the trajectory of the extension cable 40a and the retrieval cable 40 b is adjusted to set the desired angle of chute slope for system use. The winches 130 and 135 are locked out of service and the two cables become static support members for the chute 20.

Retrieval of the escape chute 20 is accomplished by releasing the escape chute 20 from the docking portal 350, reducing the tension on the extension cable 40a, and overcoming the tension of the extension cable by reeling in the retrieval cable 40b with the retrieval winch 135. As the escape chute 20 is retracted the chute 20 is compressed and folded as indicated in FIG. 12. Once the escape chute 20 is fully compressed, it is attached to the base unit 10 by its travel attachments. Then the retrieval of the extension winch cable completes the demobilization of the personnel evacuation and rescue system.

Evacuation

Personnel evacuation is rapid. The evacuee goes to the rear of the platform 30, disconnects any fall arrest device, and dives feet first into the escape chute 20 to slide within its interior all the way to the ground. Once the escape chute 20 has been entered, the user is not required to do anything else, regardless of body size, weight, or physical condition. In addition, there are no moving mechanical parts to malfunction or fail under the hazardous conditions where the chute 20 is utilized to permit escape from the platform 30.

Because the escape chute 20 is held open by the coils of its helical expansion hoop 240, personnel can readily enter into and pass through the chute 20. Normally, the slope of the chute 20 is more pronounced adjacent the mast where the evacuee enters the chute, with the slope decreasing as the evacuee nears the proximal end of the chute 20 close to the base unit 10, generally according to a catenary curve profile. Passage through the chute 20 is fairly rapid, particularly close to the rig.

When the escape chute 20 is fully stretched, the chute 20 end adjacent the base unit is separated from the base unit portal frame 140 by a sufficiently large gap that the escaping personnel can readily step onto the ground to continue their escape.

A preferred embodiment of the chute 20 has a hammock 500 attached on one side to the bottom end of the chute 20 and on the other side to the portal frame 140 of the base unit 10. The hammock 500 is secured by a static line on the bottom of the hammock 500. As escaping personnel passes down the chute 20, the individual will pass out the bottom of the chute 20 into the hammock 500. Once in the hammock 500, the individual can easily step out of the open hammock 500 onto the ground and fully evacuate.

In the event of fire or intense infrared radiation from a fire reaching the escape chute 20, it will be directed primarily onto the outer layers of the escape chute 20. The outermost layer 270 can deteriorate without seriously impairing the strength or other functionality of the escape chute 20. The third layer, or fire protection layer 260, has very high flame and heat resistance, while the second layer, or insulative layer 250, lying just outside of the innermost layer 230 effectively prevents heat from deteriorating the innermost layer 230 for enough time to permit the escape of personnel from the work platform 30.

Application of the protective layers 250, 260, and 270 may vary according to operator preference in accord with risk assessment practices for the well site environment. In this regard, any or all of the protective layers may be omitted from the chute 20 if deemed unnecessary. Alternatively, any or all of the protective layers 250, 260, and 270 may be partially deployed along the axial length of the chute in accord with risk assessment owing to the potential “flash zone” of a fire, or, the “splash zone” of chemicals which might deteriorate exposed components of chute 20.

While the extension cable 40a is exposed close to the work platform 30, its integrity is not a prerequisite for the proper function of the chute 20 in event of an emergency fire. Rather, the retraction cable 40b, which is typically protected within the protective layers 250, 260, and 270, according to the risk assessment discussed above, provides the primary basis for supporting the chute 20 while in service. On the other hand, the extension cable 40a, which is exposed close to the work platform 30, provides only a secondary function to the chute 20, and only until its strength is deteriorated by fire or temperature in such an emergency event.

It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

What is claimed is:

1. A portable personnel evacuation system comprising:
(a) a escape chute, including multiple fabric layers and a helical extension spring; and
(b) deployment means for reciprocably moving the escape chute between a first position and a second position, wherein the first position is expanded between a ground mounted base unit and an elevated work platform and the second position is compressed and stored on the ground mounted base unit.

2. The portable personnel evacuation system of claim 1, wherein the deployment means includes
a sheave mounted on the elevated work platform;
an extension winch mounted on the base unit;
an extension cable, wherein one end of the extension cable is connected to the extension winch, a segment of the extension cable is positioned between two layers of the escape chute along the length of the escape chute, a portion of the extension cable is in communication with the sheave mounted on the work platform, and a second end of the extension cable is attached to a distal end of the escape chute;
a retrieval winch mounted on the ground mounted base unit; and
a retrieval cable, wherein one end of the retrieval cable is connected to the retrieval winch, a segment of the retrieval cable is positioned between two layers of the escape chute along the length of the escape chute, and a second end of the retrieval cable is attached to a distal end of the escape chute.

3. The portable personnel evacuation system of claim 1, wherein an interior diameter of the escape chute is lined with a first layer of high tensile strength textile and the first layer is surrounded and connected to the helical extension spring.

4. The portable personnel evacuation system of claim 3, wherein the first layer and the extension spring are surrounded by a second layer of a thermal insulation fabric layer.

5. The portable personnel evacuation system of claim 3, wherein the first layer and the extension spring are surrounded by a third layer of a fire resistant fabric layer.

6. The portable personnel evacuation system of claim 3, wherein the first layer and the extension spring are surrounded by a second layer of a thermal insulation fabric layer and by a third layer of a fire resistant fabric layer.

7. The portable personnel evacuation system of claim 1, wherein the escape chute is deployable at a wide array of angles from the work platform.

8. A portable personnel evacuation system for evacuating personnel from elevated structures comprising:
(a) a ground mounted base unit, wherein the base unit includes an extension winch connected to a first end of an extension cable and a retrieval winch connected to a first end of a retrieval cable;
(b) a multi-layered escape chute, wherein a portion of the extension cable and the retrieval cable traverse a length of the escape chute between two layers of the chute and wherein a second end of the extension cable and the retrieval cables are connected to a platform end of the escape chute; and
(c) a sheave mounted on a docking portal of an elevated work platform, wherein a length of the extension cable communicates with the sheave.

9. The portable personnel evacuation system of claim 8, wherein a metal launch frame is mounted on the platform end of the escape chute.

10. The portable personnel evacuation system of claim 9, wherein the second end of the extension cable and the retrieval cables are attached to the launch frame of the escape chute.

11. The portable personnel evacuation system of claim 8, wherein the launch frame is releaseably secured to the docking portal of the work platform.

12. The portable personnel evacuation system of claim 8, wherein the escape chute is releaseably secured to the docking portal of the work platform.

13. The portable personnel evacuation system of claim 8, wherein a fall restraint anchor hook is mounted on the docking portal.

14. The portable personnel evacuation system of claim 8, wherein the multi-layered escape chute has multiple fabric layers and a helical extension spring.

15. The portable personnel evacuation system of claim 14, wherein an interior diameter of the escape chute is lined with a first layer of high tensile strength textile and the first layer is surrounded and connected to the helical extension spring.

16. The portable personnel evacuation system of claim 15, wherein the first layer and the extension spring are surrounded by a second layer of a thermal insulation fabric layer.

17. The portable personnel evacuation system of claim 15, wherein the first layer and the extension spring are surrounded by a third layer of a fire resistant fabric layer.

18. The portable personnel evacuation system of claim 15, wherein the first layer and the extension spring are surrounded by a second layer of a thermal insulation fabric layer and by a third layer of a fire resistant fabric layer.

19. The portable personnel evacuation system of claim 14, wherein the helical extension spring is metal.

20. The portable personnel evacuation system of claim 8, wherein the escape chute is deployable at a wide array of angles from the docking portal.

21. A portable personnel evacuation system for evacuating personnel from elevated structures comprising:
(a) a ground mounted base unit positioned at a predetermined distance from a well, wherein the base unit includes an extension winch connected to a first end of an extension cable, and a retrieval winch connected to a first end of a retrieval cable;
(b) a tubular escape chute that is selectably extendable, the escape chute having multiple flexible fabric layers and a helical extension spring, wherein a portion of the extension cable and the retrieval cable traverse a length of the escape chute between two layers of the chute and wherein a second end of the extension cable and the retrieval cables are connected to a launch frame mounted on a distal end of the escape chute;
(c) a docking portal mounted on an elevated work platform; and
(c) a sheave mounted on the docking portal, wherein a length of the extension cable communicates with the sheave when the escape chute is being extended between the ground mounted base unit and the docking portal.

22. The portable personnel evacuation system of claim 21, wherein a fall restraint anchor hook is mounted on the docking portal of the work platform.

23. The portable personnel evacuation system of claim 21, wherein the extension cable and the retrieval cable are made of a durable, flexible, and non-metallic material.

24. The portable personnel evacuation system of claim 21, wherein an interior diameter of the escape chute is lined with a first layer of high tensile strength textile and the first layer is surrounded and connected to the helical extension spring.

25. The portable personnel evacuation system of claim 24, wherein the first layer and the extension spring are surrounded by a second layer of a thermal insulation fabric layer.

26. The portable personnel evacuation system of claim 24, wherein the first layer and the extension spring are surrounded by a third layer of a fire resistant fabric layer.

27. The portable personnel evacuation system of claim 24, wherein the first layer and the extension spring are surrounded by a second layer of a thermal insulation fabric layer and by a third layer of a fire resistant fabric layer.

28. The portable personnel evacuation system of claim 21, wherein the escape chute is deployable at a wide array of angles from the docking portal.
